(19) United States
(12) Patent Application Publication
(10) Pub. No.: US 2014/0173397 A1
(43) Pub. Date: Jun. 19, 2014

(54) Automated Document Composition Using Clusters

(71) Applicants: Jose Bento Ayres Pereira, Palo Alto, CA (US); Keyen Liu, Beijing (CN); Lei Wang, Beijing (CN); Niranjan Damera-Venkata, Chennai, Tamil Nadu (IN)

(72) Inventors: Jose Bento Ayres Pereira, Palo Alto, CA (US); Keyen Liu, Beijing (CN); Lei Wang, Beijing (CN); Niranjan Damera-Venkata, Chennai, Tamil Nadu (IN)

(21) Appl. No.: 14/234,154

(22) PCT Filed: Jul. 22, 2011
(86) PCT No.: PCT/CN2011/001203

§ 371 Date: Jan. 22, 2014

(51) Int. Cl. G06F 17/24

(52) U.S. Cl. CPC G06F 17/248
USPC 715/202

(57) ABSTRACT

Systems and methods of automated document composition using clusters are disclosed. In an example, a method comprises determining a plurality of composition scores Φ_{A}(A, B), the composition scores each computing separately on a plurality of worker nodes in the cluster. The method also includes determining coefficients (τᵢ(A) at a master node in the cluster based on the composition scores (Φᵢ) from each of the worker nodes. The method also includes outputting an optimal document (D*) using the coefficients (τᵢ).

### BACKGROUND

Micro-publishing has exploded on the Internet, as evidenced by a staggering increase in the number of blogs and social networking sites. Personalizing content allows a publisher to target content for the readers (or subscribers), allowing the publisher to focus on advertising and tap this increased value as a premium. But while these publishers may have the content, they often lack the design skill to create compelling print magazines, and often cannot afford expert graphic design. Manual publication design is expertise intensive, thereby increasing the marginal design cost of each new edition. Having only a few subscribers does not justify high design costs. And even with a large subscriber base, macro-publishers can find it economically infeasible and logistically difficult to manually design personalized publications for all of the subscribers. An automated document composition system could be beneficial.

### BRIEF DESCRIPTION OF THE DRAWINGS

FIG. 1 shows an example of a template for a single page of a mixed-content document.

FIG. 2 shows the example template in FIG. 1 where two images are selected for display in the image fields.

FIG. 3A is a high-level diagram showing an example implementation of automated document composition using PDM.

FIG. 3B is a high-level diagram showing an example template library.

FIGS. 4A-D show an example variable template in a template library.

FIG. 5 is a high-level illustration of example automated document composition in server clusters.

FIG. 6 is a high-level block diagram showing example hardware that may be implemented for automated document composition in server clusters.

FIG. 7 is a flowchart showing example operations for automated document composition in server clusters.

### DETAILED DESCRIPTION

Automated document composition is a compelling solution for micro-publishers, and even macro-publishers. Both benefit by being able to deliver high-quality, personalized publications (e.g., newspapers, books and magazines), while reducing the time and associated costs for design and layout. In addition, the publishers do not need to have any particular level of design expertise, allowing the micro-publishing revolution to be transferred from being strictly “online” to more traditional printed publications.

Mixed-content documents used in both online and traditional print publications are typically organized to display a combination of elements that are dimensioned and arranged to display information to a reader (e.g., text, images, headers, sidebars), in a coherent, informative, and visually aesthetic manner. Examples of mixed-content documents include articles, flyers, business cards, newsletters, website displays, brochures, single or multi page advertisements, envelopes, and magazine covers, just to name a few examples. In order to design a layout for a mixed-content document, a document designer selects for each page of the document a number of elements, element dimensions, spacing between elements called “white space,” font size and style for text, background, colors, and an arrangement of the elements.

Arranging elements of varying size, number, and logical relationship onto multiple pages in an aesthetically pleasing manner can be challenging, because there is no known universal model for human aesthetic perception of published documents. Even if the published documents could be scored on quality, the task of computing the arrangement that maximizes aesthetic quality is exponential to the number of pages and is generally regarded as intractable.

The Probabilistic Document Model (PDM) overcomes these classical challenges by allowing aesthetics to be encoded by human graphic designers into elastic templates, and efficiently computing the best layout while also maximizing the aesthetic intent. While the computational complexity of the serial PDM is linear in the number of pages and in content units, the performance is insufficient for interactive applications, where either a user is expecting a preview before placing an order, or is expecting to interact with the layout in a semi-automatic fashion.

Advances in computing devices have accelerated the growth and development of software-based document layout design tools and, as a result, have increased the efficiency with which mixed-content documents can be produced. A first type of design tool uses a set of gridlines that can be seen in the document design process but are invisible to the document reader. The gridlines are used to align elements on a page, allow for flexibility by enabling a designer to position elements within a document, and even allow a designer to extend portions of elements outside of the guidelines, depending on how much variation the designer would like to incorporate into the document layout. A second type of document layout design tool is a template. Typical design tools present a document designer with a variety of different templates to choose from for each page of the document.

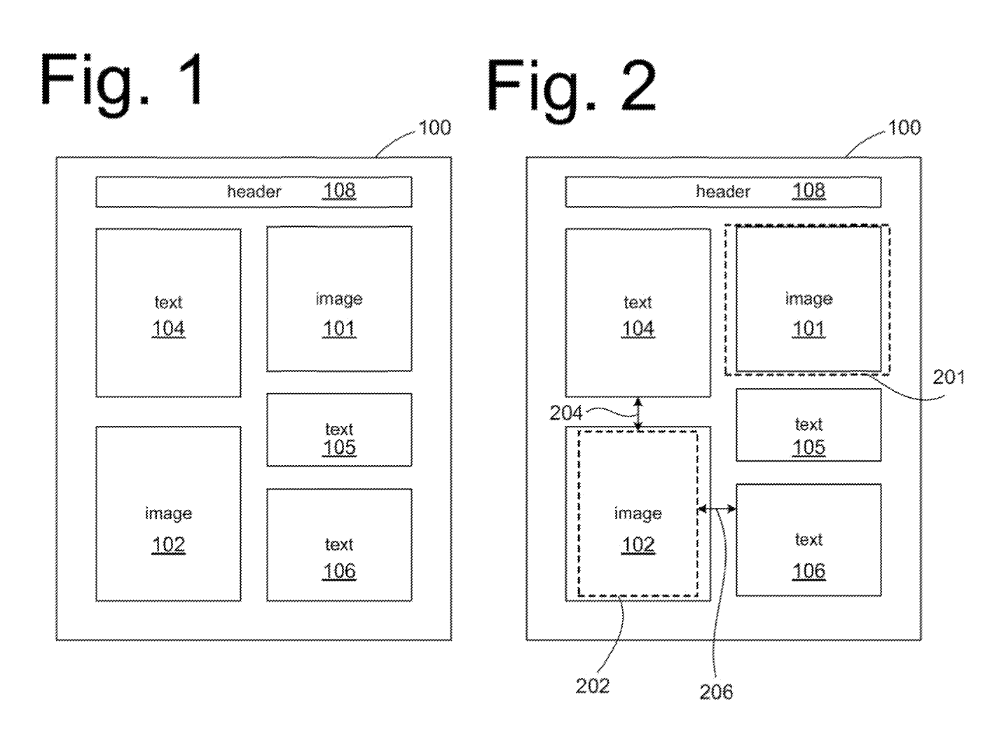

FIG. 1 shows an example of a template 100 for a single page of a mixed-content document. The template 100 includes two image fields 101 and 102, three text fields 104-106, and a header field 108. The text, image, and header fields are separated by white spaces. A white space is a blank region of a template separating two fields, such as white space 110 separating image field 101 from text field 105. A designer can select the template 100 from a set of other templates, input image data to fill the image fields 101 and text data to fill the text fields 104-106 and the header 108.

However, many procedures in organizing and determining an overall layout of an entire document continue to require numerous tasks that are to be completed by the document designer. For example, it is often the case that the dimensions of template fields are fixed, making it difficult for document designers to resin images and arrange text to fill particular fields creating image and text overflows, cropping, or other unpleasant scaling issues.

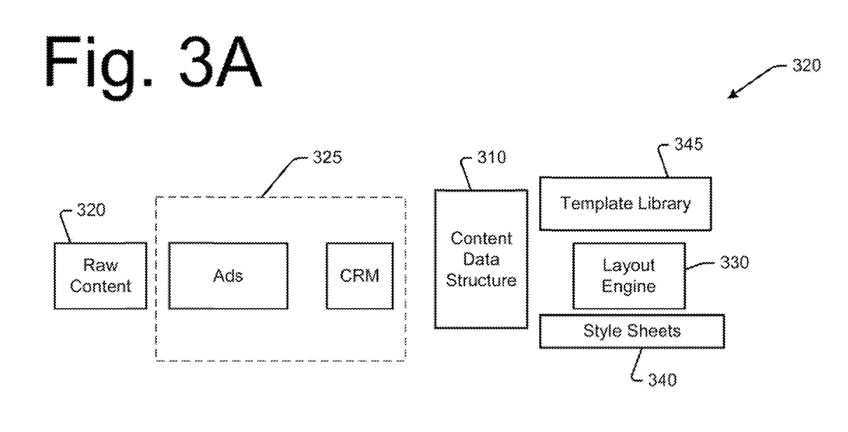

FIG. 2 shows the template 100 where two images, represented by dashed-line boxes 201 and 202, are selected for display in the image fields 101 and 102. As shown in the example of FIG. 2, the images 201 and 202 do not fit appropriately within the boundaries of the image fields 101 and 102. With regard to the image 201, a design tool may be configured to crop the image 201 to fit within the boundaries of the image field 101 by discarding what it determines as peripheral portions of the image 201, or the design tool may attempt to fit the image 201 within the image field 101 by rescaling the aspect ratio of the image 201, resulting in a visually displeasing distorted image 201. Because image 202 fits within the boundaries of image field 102 with room to spare, white spaces 204 and 206 separating the image 202 from the text fields 104 and 106 exceed the size of the white spaces separating other elements in the template 100 resulting in a visually distracting uneven distribution of the elements. The design tool may attempt to correct for this by rescaling the aspect ratio of the image 202 to fit within the boundaries of the image field 102, also resulting in a visually displeasing distorted image 202.

The systems and methods described herein use automated document composition for generating mixed-content documents. Automated document composition can be used to transform marked-up raw content into aesthetically-pleasing documents. Automated document composition may involve pagination of content, determining relative arrangements of content blocks and determining physical positions of content blocks on the pages.

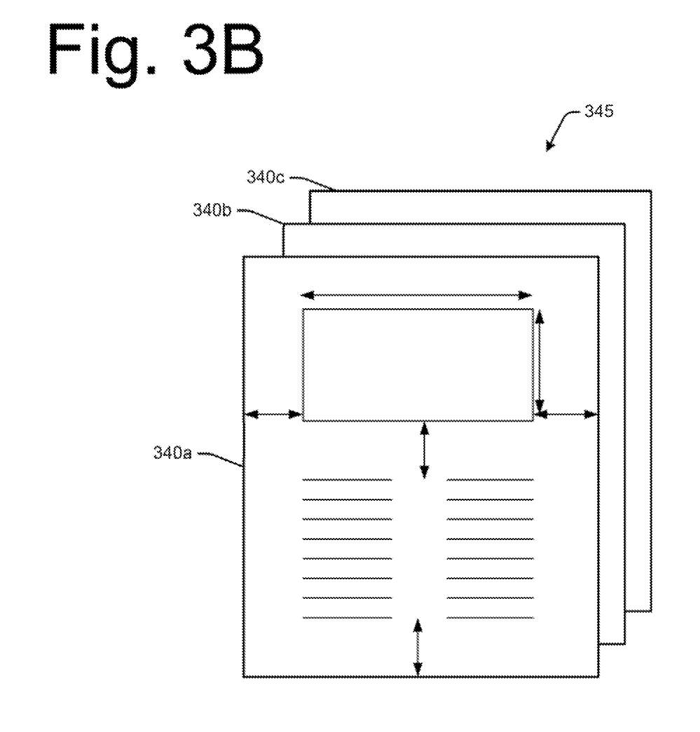

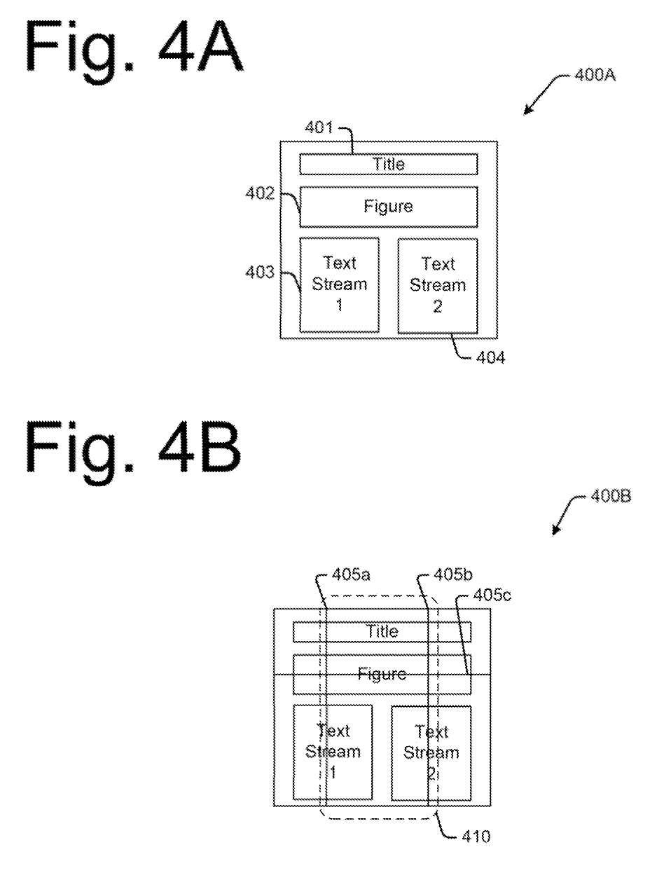

FIG. 3A is a high-level diagram 300 showing an example implementation of automated document composition using PDM. The content data structure 310 represents the input to the layout engine. In an example, the content data structure is an XML file. In a typical magazine example, there may be a stream of text, a stream of figures, a stream of sidebars, a stream of pull quotes, a stream of advertisements, and logical relationships between them. For purposes of illustration, FIG. 3A shows a stream of text blocks, a stream of figures, and the logical linkages.

In the example shown in FIG. 3A, the content 320 is decoupled from the presentation 325 which allows variation in the size, number and relationship among content blocks, and is the input to the automated publishing engine 330. Adding or deleting elements may be accomplished by addition or deletion of sub-trees in the XML structure 310. Content modifications simply amount to changing the content of an XML leaf-node.

Each content data structure 310 (e.g., an XML file) is coupled with a template or document style sheet 340 from a template library 345. Content blocks within the XML file 310 have attributes that denote type. For example, text blocks may be tagged as head, subhead, list, pare, caption. The document style sheet 340 defines the type definitions and the formatting for these types. Thus the style sheet 340 may define a head to use Arial bold font with a specified font size, line spacing, etc. Different style sheets 340 apply different formatting to the same content data structure 310.

It is noted that type definitions may be scoped within elements, so that two different types of sidebars may have different text formatting applied to text with a subhead attribute. The style sheet also defines overall document characteristics such as, margins, bleeds, page dimensions, spreads, etc. Multiple section of the same document may be formatted with different style sheets.

Graphic designers may design a library of variable templates. An example template library 345 is shown in high-level in FIG. 38. Having human-developed templates 340a-c addresses creating an overarching model for human aesthetic perception. Different styles can be applied to the same template via style sheets as discussed above.

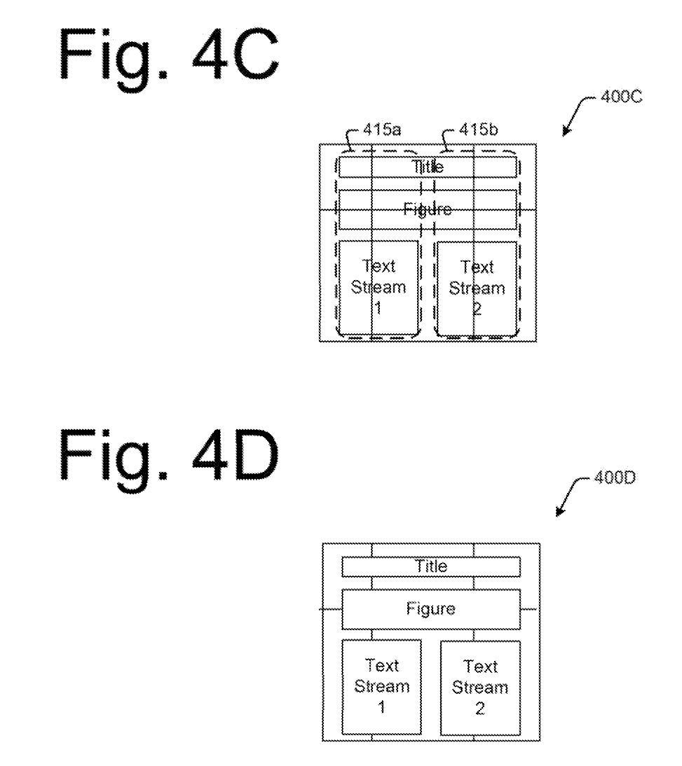

FIGS. 4A-D show an example variable template in the template library. The template parameters (Θ's) represent white space, figure scale factors, etc. The design process to crests a template may include content block layout, specification of dimension (x and y) optimization paths and path groups, and specification of prior probability distributions for individual parameters.

A content block layout is illustrated in FIG. 4A. A designer may place content rectangles 401-404 on the design canvas 400. Three types of content blocks are supported in this example, including title 401, figure 402, and text blocks 403-404. It is noted that text blocks 403-404 represent streams of text sub-blocks, and may include headings, subheadings, list items, etc. The types and formatting of sub-blocks that go in a text stream are defined in the document style sheet. Each template has attributes, such as background color, background image, first page template flag, last page template flag etc. that allow for common template customizations.

To specify paths and path groups, the designer may draw vertical and horizontal lines 405a-c across the page indicating paths what the layout engine optimizes. Specification of a path indicates the designer goal that content blocks and whitespace along the path conform to specified path heights (widths). These path lengths may be set to the page height (width) to encourage the layout engine to produce full pages with minimized under and overfill. Paths may be grouped together to indicate that text flow from one path to the next. FIG. 4B is a design canvas 400B showing an example path 405a-c and path group 410 specification. Further, content may be grouped together as a sidebar. FIG. 4C is a design canvas 400C showing a sidebar grouping 415a-b where the figure and text stream are grouped together into a sidebar. Thus FIG. 4B shows two Y paths grouped into a single Y-path group 410, and FIG. 4C shows two Y paths grouped into two Y-Path groups 415a-b. The second Y-path group 415b contains a sidebar grouping. Text is not allowed to flow outside a sidebar or from one Y-path group to the next.

When the designer selects variable entry (e.g., in the user interface), the figure areas and X and Y whitespaces are highlighted for parameter specification (e.g., as illustrated by design canvas 400D in FIG. 4D). The parameters are set to fixed values inferred from the position on the canvas. The designer clicks on parameters that are to be variable and enters a minimum value, a maximum value, a mean value and a precision value for each desired variable. This process specifies a “prior” Gaussian distribution for each of the template parameters. It is a “prior” Gaussian distribution in the sense that it is specified before seeing actual content. For figures, width and height ranges, and a precision value for the scale factor are specified. The mean value of the scale parameter is automatically determined by the layout engine based on the aspect ratio of en actual image so as to make the figure as large as possible without violating the specified range conditions on width and height. Thus the scale parameter of a figure has a truncated Gaussian distribution with truncation at the mean. The designer can make aesthetic judgments regarding relative block placement, whitespace distribution, figure scaling etc. The layout engine strives to respect this designer “knowledge” as encoded into the prior parameter distributions.

The layout engine includes three components. A parser parses style sheets, templates, and input content into internal data structures. An inference engine computes the optimal layouts, given content. A rendering engine renders the final document.

There are three parsers, one each for style sheets, content, and templates. The style sheet parser reads the style sheet for each content stream and creates a style structure that includes document style and font styles. The content parser reads the content stream and creates an array of structures for figures, text and sidebars respectively.

The text structure array (also referred to herein as a “chunk array”) includes information about each independent “chunk” of text that is to be placed on the page. A single text block in the content stream may be chunked as a whole if text cannot flow across columns or pages (e.g., headings and text within sidebars). However, if the text block is allowed to flow (e.g., paragraphs and lists), the text is first decomposed into smaller chunks that are rendered atomically. Each structure in the chunk array can include an index in the array, chunk height, whether a column or page break is allowed at the chunk, the identity of the content block to which the chunk belongs, the block type and an index into the style array to access the style to render the chunk. The height of a chunk is determined by rendering the text chunk at all possible text widths using the specified style in an off screen rendering process. In en example, the number of lines and information regarding the font style and line spacing is used to calculate the rendered height of a chunk.

Each figure structure in the figure array encapsulates the figure properties of an actual figure in the content stream such as width, height, source filename, caption and the text block identity of a text block which references the figure. Figure captions are handled similar to a single text chunk described above allowing various caption widths based on where the caption actually occurs in a template. For example, full width captions span text columns, while column width captions span a single text column.

Each content sidebar may appear in any sidebar template slot (unless explicitly restricted), so the sidebar array has elements that are themselves arrays with individual elements describing allocations to different possible sidebar styles. Each of these structures has a separate figure array and chunk array for figures and text that appear within a particular template sidebar.

The inference engine is part of the layout engine. Given the content, style sheet, and template structures, the inference engine solves for a desired layout of the given content. In en example, the inference engine simultaneously allocates content to a sequence of templates chosen from the template library, and solves for template parameters that allow maximum page fill while incorporating the aesthetic judgements of the designers encoded in the prior parameter distributions. The inference engine is based on a framework referred to as the Probabilistic Document Model (PDM), which models the creation and generation of arbitrary multi-page documents.

A given set of all units of content to be composed (e.g., images, units of text, and sidebars) is represented by a finite set c that is a particular sample of content from a random set C with sample space comprising sets of all possible content input sets. Text units may be words, sentences, lines of text, or whole paragraphs. Text units may be words, sentences, lines of text, or whole paragraphs. To use lines of text as an atomic unit for composition, each paragraph is decomposed first into lines of fixed column width. This can be done if text column widths are known and text is not allowed to wrap around figures. This method is used in all examples due to convenience and efficiency.

The term c′ denotes a set comprising all sets of discrete content allocation possibilities over one or more pages, starting with and including the first page. Content subsets that do not form valid allocations (e.g., allocations of non-contiguous lines of text) do not exist in c′. If there are 3 lines of text and 1 floating figure to be composed, e.g., c={l₁, l₂, l₂, f₁} while c′={{l₁, }, {l₁, l₂}, {l₁, l₂, l₃}, {f₁}, {l₁f₁}, {l₁, l₂, f₁}, {l₁l₂, l₃, f₁}} ∪ {0}. It is noted that the specific order of elements within an allocation set is not necessary, because {l₁, l₂, f₁} and {l₂, f₁, l₂} refer to an allocation of the same content. However an allocation {l₁, l₃, f₁} ∉ c′ means that lines 1 and 3 cannot be in the same allocation without including line 2. In addition, c′ includes the empty set to allow for the possibility of a null allocation.

The index of a page is represented by i≧0. Cᵢ is a random set representing the content allocated to page i. C≦i ∈ c′ is a random set of content allocated to pages with index 0 through i. Hence:

C_{≦i}=∪ⱼ₌₀ⁱCⱼ

If Cₛᵢ=Cₛᵢ₋₁, then Cₗ=0 (i.e., page i has no content allocated). For convenience of this discussion, C_{≦i}=0 and all pages i≧0 have valid content allocations to the previous i-l pages.

The probabilistic document model (PDM) is a probabilistic framework for adaptive document layout that supports automated generation of paginated documents for variable content. PDM encodes soft constraints (aesthetic priors) on properties, such as, whitespace, image dimensions, and image resealing preferences, and combines all of these preferences with probabilistic formulations of content allocation and template choice into a unified model According to PDM, the i^{th} page of a probabilistic document may be composed by first sampling random variable Tᵢ from a set of template indices with a number of possible template choices (representing different relative arrangements of content), sampling a random vector θᵢ of template parameters representing possible edits to the chosen template, and sampling a random set Cᵢ of content representing content allocation to that page (or “pagination”). Each of these tasks is performed by sampling from an underlying probability distribution.

Thus, a random document can be generated from the probabilistic document model by using the following sampling process for page i≧0 with C_{≦-l}=0;
sample template t, from [symbol] ᵢ(Tᵢ)
sample parameters θᵢ from [symbol] (Θᵢ|tᵢ)
sample content c_{≦i} from [symbol] (C_{≦i}|c_{≦i-1}, θₜ, lᵢ)

cᵢ=c_{≦i}−c_{≦i-1}

The sampling process naturally terminates when the content runs out. Since this may occur at different random page counts each time the process is initiated, the document page count I is itself a random variable defined by the minimal page number at which C_{≦1}=c. A document V in PDM is thus defined by a triplet D of random variables representing the various design choices made in the above equations.

For a specific content c, the probability of producing document D of I pages via the sampling process described in this section is simply the product of the probabilities of all design (conditional) choices made during the sampling process. Thus,

$$ℙ ( 𝒟 ; I ) = {\prod }_{i = 0}^{I - i} ℙ ( {𝒞}_{\leq i} \vert {C}_{\leq i - 1} , {Θ}_{i} , {T}_{i} ) ℙ ( {Θ}_{i} \vert {T}_{i} ) {ℙ}_{i} ( {T}_{i} )$$

The task of computing the optimal page count and the optimizing sequences of templates, template parameters, content allocations that maximize overall document probability is referred to herein as the model inference task, which can be expressed as:

$$( {𝒟}^{*} , {I}^{*} ) = {argmax}_{𝒟 , I \geq 1} ℙ ( 𝒟 ; I )$$

The optimal document composition may be computed in two passes. In the forward pass, the following coefficients are recursively computed, for all valid content allocation sets A⊃B as follows

$$Ψ ( 𝒜 , ℬ , T ) = {max}_{Θ} ℙ ( 𝒜 \vert ℬ , Θ , T ) ℙ ( Θ \vert T )$$

$${Φ}_{i} ( 𝒜 , ℬ ) = {max}_{T ∈ {Ω}_{s}} Ψ ( 𝒜 , ℬ , T ) {ℙ}_{i} ( T ) , i \geq 0 , \\ {τ}_{i} ( 𝒜 ) = {max}_{ℬ} Φ , ( 𝒜 , ℬ ) {τ}_{i - 1} ( ℬ ) , i \geq 1$$

In the equations above, τ₀(A)=Φ₀(A, 0). Computation of τᵢ(A) depends on Φₜ(A, B), which in turn depends on ψ(A, B, T). In the backward pass, the coefficients computed in the forward pass are used to infer the optimal document. This process is very fast, involving arithmetic and lookups. The entire process is dynamic programming with the coefficients τᵢ(A), Φᵢ(A, B) and ψ(A, B, T) playing the role of dynamic programming tables. The following discussion focuses on parallelizing the forward pass of PDM inference, which is the most computationally intensive part.

The innermost function ψ(A, B, T) can be determined as a score of how we content in the set A-B is suited for template T. This function is the maximum of a product of two terms. The first term [symbol] (A|B, Θ, T) represents how we content fills the page and respects figure references, while the second term [symbol] (ƒ|T) assesses how close, the parameters of a template are to the designer's aesthetic preference. Thus the overall probability (or “score”) is a tradeoff between page fill and a designer's aesthetic intent. When there are multiple parameters settings that fill the page equally well, the parameters that maximize the prior (and hence are closest to the template designer's desired values) are favored.

The function Φᵢ(A, B) scores how well content A-B can be composed onto the i^{th} page, considering all possible relative arrangements of content (templates) allowed for that page. [symbol] ᵢ(T) allows the score of certain templates to be increased, thus increasing the chance that these templates are used in the final document composition.

Finally function τᵢ(A) is a pure pagination score of the allocation A to the first i pages. The recursion τᵢ(A) means that the pagination score for an allocation A to the first i pages, τᵢ(A) is equal to the product of the best pagination score over all possible previous allocations B to the previous (i−1) pages with the score of the current allocation A-B to the i^{th} page (A, B).

The PDM process can be used to back out the optimal templates to compose each page of the document composition. The way in which these calculations are distributed among different computational units in a server cluster processing environment has to do with the degree of dependency and synchronization mechanisms. Three types of degrees of dependency can be distinguished among the computations: (a) independent computations, (b) dependent computations, and (c) partially dependent computations.

An example of independent computations is the sums involved in the component-wise sum of two vectors (a, b). The sum of each component, (aᵢ+bᵢ) is unrelated to the sum the other components. Therefore, it does not matter if the threads to which each of these sums is assigned can communicate with each other.

An example of dependent computations is the calculations involved in obtaining all the values of a recursion, such as xᵢ₊₁=f (xᵢ). Proceeding to compute x₁₀ occurs after computing x₉. Hence, all of these computations can be computed by the same thread sequentially. There can be less benefit in having different threads to compute these different xᵢ, either inside different thread-blocks or using the same thread-blocks.

An example of partially dependent computations is the comparisons involved in determining the maximum value over a set of values using parallel reduction, e.g., max_{ic(1, 2, . . . 32)} θᵢ. At an initial stage, b1 is computed as b₁=max(a₁, a₁₇), b2=max(a₂, a₁₈), . . . b₁₆=max(a₁₆, a₃₂). However, computations cannot proceed to the next process, e.g., computing c₁=max{b₁, b₈}, c₂=max{b₂, b₉}, . . . cₛ=max{b₈, b₆}), until all b's have been calculated. In short, there is some dependency among the computations, and although at a given level (e.g., bᵢs level) each comparison can be done in a separate thread, all threads should belong to the same block so that after each process the output can synchronize before going to the next process in the reduction.

The automated publishing can be executed in a server cluster processing environment using these general notions of dependency. In an example, serial procedures (e.g., shown herein as algorithms) may be mapped to multiple server nodes using a computational paradigm known as “MAP-REDUCE.” MAP-REDUCE is a software framework first introduced in the computing industry to support distributed computing on large data sets on clusters of computers. MAP-REDUCE is now available on many commercial cloud computing offerings.

In a MAP operation, a master node converts an input “problem” into smaller “sub-problems,” and distributes those sub-problems to “worker” nodes. The worker node processes the sub-problem, and passes a result back to a master node. In the REDUCE operation the master node then takes the results from all of the sub-problems and combines the results to obtain a solution to the input problem.

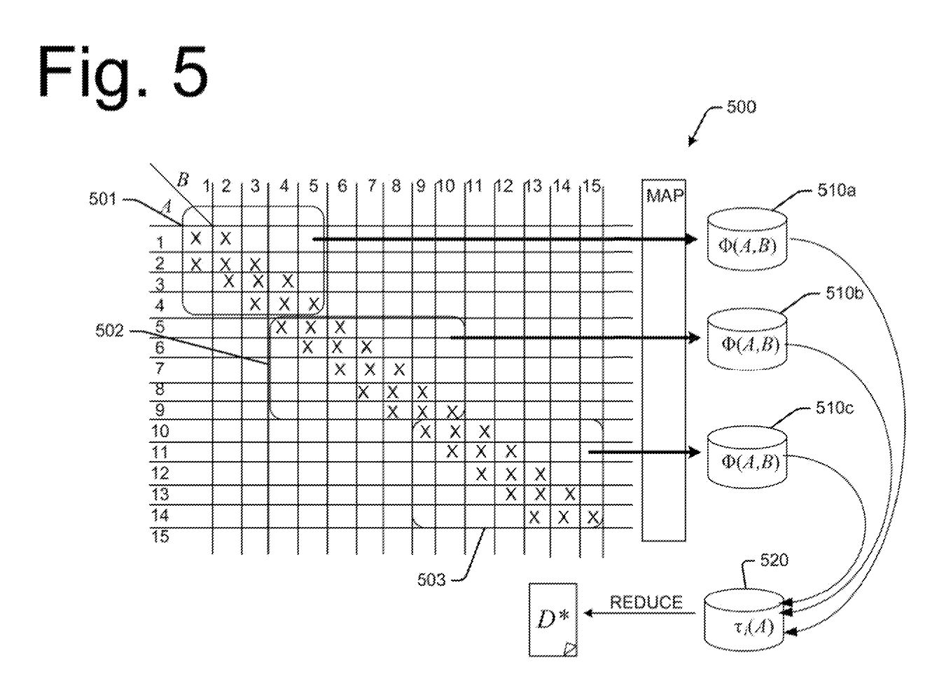

FIG. 5 is a high-level illustration of example automated document composition in server clusters. In this example it can be seen how the computation of Φs may be distributed to the worker nodes. It can also be seen how the collected data can be “REDUCED” to compute the rs on the master node.

In an example, the sub-problems sent to the server nodes are the computation of the Φᵢ(A, B) for all:

A, B ∈ C′

The set A-B can be effectively bound to represent the content allocated to a page. This implies that all legal subsets A and B do not need to considered in building Φᵢ(A, B), but those that are close enough are considered so that the content A-B can reasonably be expected to fit on a page. The computation of (A, B) depends on i since the maximization over allowed templates for each page in Φᵢ(A, B) occurs over sub-libraries that depend on i. However, since in practice the number of distinct template sub-libraries is quite small (typically first, last, odd and even page templates are drawn from distinct libraries), the computation of Φ_{f}(A, B) for any i can be reduced to computation of Φ_{first}(A, B), Φₗₐₛₜ(A, B), Φ_{odd}(A, B) and Φₑᵥₑₙ(A, B). This means that each distributed server node essentially computes odd (A, B) and even (A, B) for most content. As a simplification (without loss of generality) all templates for all pages are sampled from a single template library, so the subscript can he dropped and Φ_{f}(A, B) can be written asΦ(A, B).

FIG. 5 shows how the computation of the Φs can be distributed to the worker nodes, and shows how the collected data may be reduced to compute the τs on the master node. To provide intuition about the mapping, each content allocation set in c′ is associated with a number. Close numbers represent close sets, and supersets receive larger numbers than subsets. Therefore, a grid of possible content allocations (A, B) can be assumed, as shown in FIG. 1. Because A-B represents the content allocated to a page, it is bounded by page dimensions.

Accordingly, relatively few diagonal and neighboring elements are actually computed (regions designated “X” in FIG. 5), although each node 510a-c receives a block of computation (blocks inside boundaries 501-503 without an “X” designation in FIG. 5). The content allocations lie along the diagonal of the grid if there is a single possible content ordering (no floating elements).

It is noted that the illustration shown in FIG. 5 is intended to provide a visual representation showing that a small portion of the entire grid has meaningful allocations for which (A, B) are computed. In general, for each A the allowed B's are in a neighborhood which can be expressed as:

N_{f}(A)={B:d(A-B)≦f}

The function d(A-B) returns a vector of the counts of various page elements in the set A-B. f is a vector that expresses what is meant to be close by bounding the numbers of various page elements allowed on a page. For example f=[100(lines), 2(figures), 1(sidebar)]^{T}. This eliminates an allocation where d(A-B)=[110(lines), 2(figures), 1(sidebar)]^{T}.

The master node 520 receives all the computed Φs from worker nodes 510a-c, and computes the τ_{f}(A) coefficients. Master node 520 also performs a sequential backward pass algorithm (associated with the procedure) to obtain the final document D*. Pseudo code for the Map and Reduce functions is shown for an example below by Algorithms 2 and 3. With reference to FIG. 5, instead of a full block decomposition, a row-based decomposition is used for the Map operation. Thus each Map computes (A, B) for a given A for B's in the neighborhood of A. Line 3 in the example Algorithm 1 may be computed efficiently if the distributions are parameterized.

Algorithm 1 Code to compute Φ(A, B) in Map step

1: Φ(A, B) = 0
2: for all T ε Ω do
3: Ψ(A, B, T) = max_{Θ} [symbol] (A|B, Θ, T) [symbol] (Θ|T)
4: if Φ(A, B) < Ψ(A, B, T) [symbol] (T) then
5: Φ(A, B) = Ψ(A, B, T) [symbol] (T)
6: end if
7: end for

Algorithm 2 Map(key = A, value = f)

1: for all B ε c^{l} : A − B ε N_{f}(A) do
2: Emit key = “l”, value = (A, B, Φ(A, B))
3: end for

Algorithm 3 Reduce(key = “l”, values = (A, B, Φ(A, B) ) ∀ A, B

1: τ₀(A) = Φ₀(A, ), ∀ A ε c^{l}
2: τᵢ(A) = 0, ∀ A ε c¹, ∀i ≧ 1
3: for all A do
4: for all B corresponding to specific A do
5: for i = 1 to I do
6: if τᵢ(A) ≦ Φ(A, B)τᵢ₋₁(B) then
7: τᵢ(A) = Φ(A, B)τᵢ₋₁(B)
8: end if
9: end for
10: end for
11: Emit key=(i,A) value = τᵢ (A)
12: end for

The information that each computer receives initially is a data structure containing the layout information of each piece involved in composing the document. This structure includes the dimensions of each picture, the layout of each template, the structure of each side bar and the size of each line of text, it is noted, however, that this structure does not include the actual lines of text or images that go into composing the final document. The structures therefore a small byte size.

A simple formula is deduced that shows how the theoretical total operation time depends on the number of computers, N, among which the work is distributed. Let the number of sets A for which to compute (A, B) be N_{C}, a constant. Now assume A is fixed, since there is a restriction on the maximum content per page, the number of sets B for which are going to compute (A, B), is bounded by a constant. In the beginning, the same data structure is broadcast to all of the nodes. This takes a fixed time tD. After that, each of the N nodes computes a set of coefficients. This computation is done in parallel among all nodes, and takes a time proportional to N_{C}I N. After all the coefficients are computed, the coefficients are transmitted to the (N+1)th node. Since there is one receiving node, and because the amount of information to be transmitted by each node is proportional to the number of coefficients, this takes a time that is proportional to N×(N_{C}/N). After the Reducer receives all the coefficients, this node computes the τᵢ(A) coefficients and determines the optimal document.

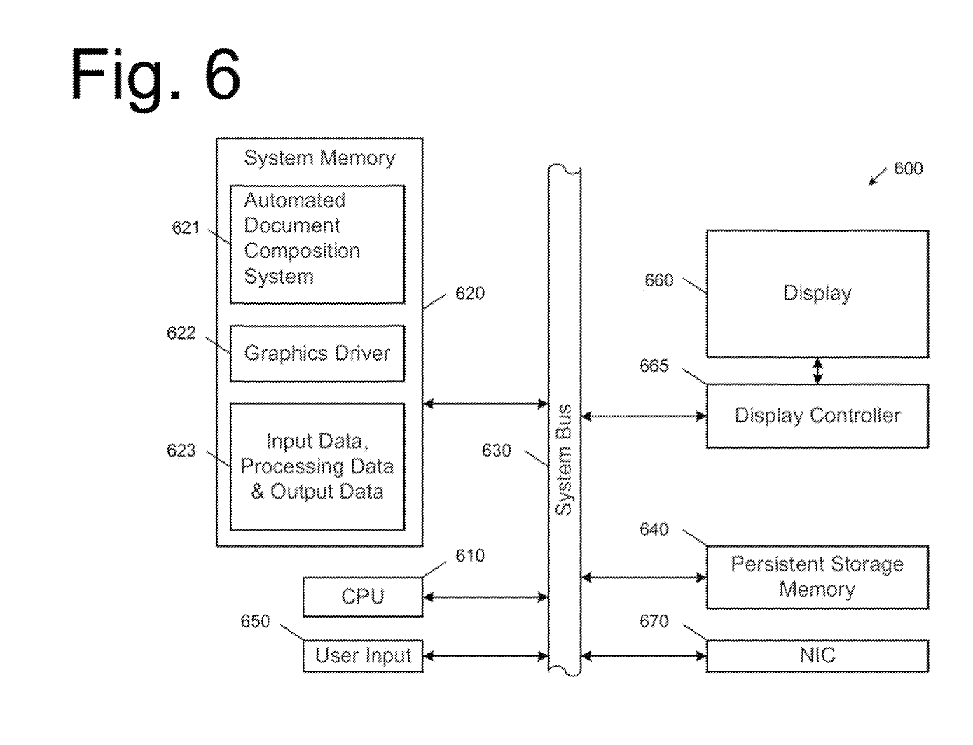

FIG. 6 is a high-level block diagram 600 showing example hardware that may be implemented for automated document composition. In this example, a computer system 600 is shown that can implement any of the examples of the automated document composition system 621 that are described herein. The computer system 600 includes a processing unit 710 (CPU), a system memory 620, and a system bus 630 that couples processing unit 610 to the various components of the computer system 600. The processing unit 610 typically includes one or more processors, each of which may be in the form of any one of various commercially available processors. The system memory 620 typically includes a read only memory (ROM) that stores a basic input/output system (BIOS) that contains start-up routines for the computer system 600 and a random access memory (RAM). The system bus 146 may be a memory bus, a peripheral bus or a local bus, and may be compatible with any of a variety of bus protocols, including PCI, VESA, Microchannel, ISA, and EISA. The computer system 600 also includes a persistent storage memory 640 (e.g., a hard drive, a floppy drive, a CD ROM drive, magnetic tape drives, flash memory devices, and digital video disks) that is connected to the system bus 630 and contains one or more computer-readable media disks that provide non-volatile or persistent storage for data, data structures and computer-executable instructions.

A user may interact (e.g., enter commands or data with the computer system 600 using one or more input devices 650 (e.g., a keyboard, a computer mouse, a microphone, joystick, and touch pad). Information may be presented through a user interface that is displayed to a user on the display 660 (implemented by, e.g., a display monitor), that is controlled by a display controller 665 (implemented by, e.g., a video graphics card). The computer system 600 also typically includes peripheral output devices, such as a printer. One or more remote computers may be connected to the computer system 600 through a network interface card (NIC) 670.

As shown in FIG. 6, the system memory 620 also stores the automated document composition system 621, a graphics driver 622, and processing information 623 that includes input data, processing data, and output data.

The automated document composition system 621 can include discrete data processing components, each of which may be in the form of any one of various commercially available data processing chips. In some implementations, the automated document composition system 621 is embedded in the hardware of any one of a wide variety of digital and analog computer devices, including desktop, workstation, and server computers. In some examples, the automated document composition system 621 executes process instructions machine-readable instructions, such as but not limited to computer software and firmware) in the process of implementing the methods that are described herein. These process instructions, as well as the data generated in the course of their execution, are stored in one or more computer-readable media. Storage devices suitable for tangibly embodying these instructions and data include ail forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

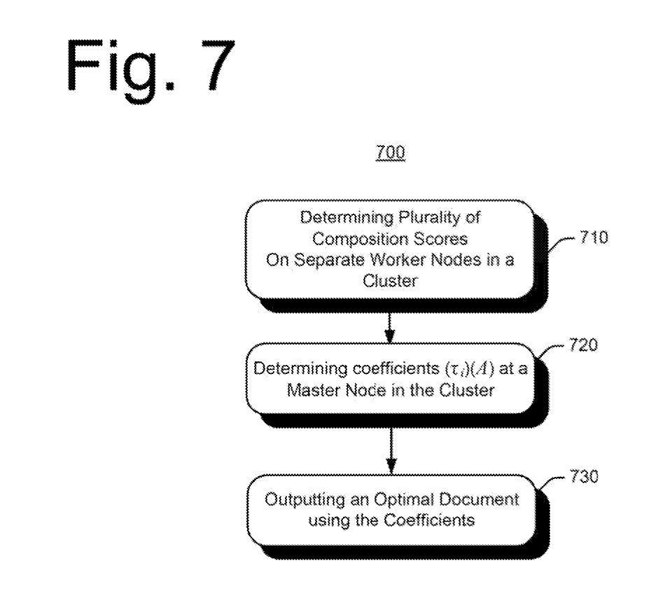

FIG. 7 is a flowchart showing example operations for automated document composition in server clusters. Operations 700 may be embodied as machine readable instructions on one or more computer-readable medium. When executed on a processor, the instructions cause a general purpose computing device to be programmed as a special-purpose machine that implements the described operations. In an example implementation, the components and connections depicted in the figures may be used.

An example of a method of automated document composition in server clusters may be carried out by program code stored on non-transient computer-readable medium and executed by processor(s).

In operation 710, determining a plurality of composition scores Φₜ(A, B), the composition scores each computing separately on a plurality of worker nodes in the duster.

In operation 720, determining coefficients (τᵢ)(A) at a master node in the cluster based on the composition scores (Φᵢ) from each of the worker nodes.

In operation 730, outputting an optimal document (D*) using the coefficients (τᵢ).

The operations shown and described herein are provided to illustrate example implementations, it is noted that the operations are not limited to the ordering shown. Still other operations may also be implemented.

In an example of further operation, A and B may be subsets of original content a (C). The composition scores may be for allocating content (A) to the first i pages in a document, and allocating content (B) to the first i−1 pages in the document. The composition scores may represent how well content A-B fits the ith page over templates T from a library of templates used to lay out original content (C).

In further operations, all Bs are computed for a given A by a single worker node.

In another example of further operations, all worker nodes may receive a data structure including layout information of each component for composing the document. The layout information may include dimensions of each component for composing the document. The layout information may include layout of each template for composing the document. The layout information may include structure of each component for composing the document. The layout information may not include actual text or images.

It is noted that the example embodiments shown and described are provided for purposes of illustration and are not intended to be limiting. Still other embodiments are also contemplated.

1. A method of automated document composition using clusters, comprising:
determining a plurality of composition scores Φ_{f}(A, B), the composition scores each computing separately on a plurality of worker nodes in the cluster;
determining coefficients (τᵢ)(A) at a master node in the duster based on the composition scores (Φᵢ) from each of the worker nodes; and
outputting an optimal document (D*) using the coefficients (τᵢ).

2. The method of claim 1, wherein A and B are subsets of original content (C).

3. The method of claim 1, wherein the composition scores are for allocating content (A) to the first i pages in a document, and allocating content (B) to the first i−1 pages in the document.

4. The method of claim 1, wherein the composition scores represent how well content A-B fits the ith page over templates T from a library of templates used to lay out original content (C).

5. The method of claim 1, wherein all Bs are computed for a given A by a single worker node.

6. The method of claim 1, wherein all worker nodes receive a data structure including layout information of each component for composing the document.

7. The method of claim 6, wherein the layout information includes dimensions of each component for composing the document.

8. The method of claim 6, wherein the layout information includes layout of each template for composing the document.

9. The method of claim 6, wherein the layout layout information includes structure of each component for composing the document.

10. The method of claim 6, wherein the layout information does not include actual text or images.

11. A system comprising a computer readable storage to store program code executable for automated document composition using clusters, the program code comprising instructions to:
determine a plurality of composition scores Φᵢ(A, B) on a plurality of worker nodes in the cluster;
determine coefficients (τᵢ)(A) at a master node in the cluster based on the composition scores (Φᵢ) from each of the worker nodes; and
output an optimal document (D*) using the coefficients (τᵢ).

12. The system of claim 11, wherein the worker nodes are provided in a cloud computing environment.

13. The system of claim 11, wherein serial operations are mapped to multiple worker nodes using “MAP-REDUCE.”

14. The system of claim 13, wherein in a MAP operation, the master node converts input into sub-problems and distributes the subproblems to the worker nodes.

15. The system of claim 14, wherein the worker nodes process the sub-problem, and return results back to the master node.

16. The system of claim 15, wherein in a REDUCE operation the master node combines the results from all of the worker nodes to determine the coefficients (τⱼ).

17. A system comprising a computer readable storage to store program code executable by a multi-core processor to:
separately compute a plurality of composition scores Φᵢ(A, B) on a plurality of worker nodes in a cluster;
compute coefficients (τᵢ)(A) at a master node in the cluster based on the composition scores (Φᵢ) from each of the worker nodes; and
output an optimal document (D*) using the coefficients (τᵢ).

18. The system of claim 17, wherein the worker nodes execute “MAP-REDUCE” in a cloud computing environment.

19. The system of claim 17, wherein all Bs ace computed for a given A by a single worker node.

20. The system of claim 17, wherein all worker nodes receive a data structure including layout information of each component of the document.
